(19) United States
(12) Patent Application Publication
(10) Pub. No.: US 2010/0200433 A1
(43) Pub. Date: Aug. 12, 2010

(54) Gas Storage and Dispensing Module

(76) Inventors: Robert Edward Stahley, Middletown, OH (US); Dimitris Ioannis Collias, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/369,864

(22) Filed: Feb. 12, 2009

(51) Int. Cl. F17C 1/00

(52) U.S. Cl. 206/6

(57) ABSTRACT

A gas storage module comprises a capacitive matrix material having a capacity ratio of at least about 3. The module also includes an outer covering surrounding the capacitive matrix material. The outer covering comprises a gas passage valve. The gas passage valve includes a gas passage channel through the outer covering. The capacitive matrix material may have a storage pressure ratio of at least about 9. The capacitive matrix material may have a dispensing performance ratio of at least about 0.6.

### FIELD OF THE INVENTION

The invention relates to methods and apparatus for the storage of gaseous materials. The invention relates particularly to methods and apparatus for the storage and dispensing of gaseous materials.

### BACKGROUND OF THE INVENTION

Equipment and apparatus for the storage of gasses is known in the art. Simple tank systems which provide for the pressurized storage of gasses are widely known. Such systems provide for gas storage but require sufficient structure to safely contain high pressures when large volumes of gas are stored in a relatively small enclosure.

Stored gas may be dispensed for a variety of applications from simple inflation to product dispensing. Additionally, gas may simply be stored as an alternative to having the gas in the environment. Storing large volumes of gas without attendant high pressures or the necessity of low temperatures is desired.

Apparatus for storing and recovering a quantity of gaseous material without the typically attendant pressure are desired.

### SUMMARY OF THE INVENTION

A gas storage module is presented and described. In one embodiment the module comprises a gas storage module. The module comprises a capacitive matrix material having a capacity ratio of at least about 3. The module also includes an outer covering surrounding the capacitive matrix material. The outer covering comprises a gas passage valve. The gas passage valve includes a gas passage channel through the outer covering.

In one embodiment the module comprises a capacitive matrix material having a storage pressure ratio of at least about 9. The module also comprises a covering surrounding the capacitive matrix material. The outer covering comprises a gas passage valve. The gas passage valve includes a gas passage channel through the outer covering.

In one embodiment the gas storage module comprises a capacitive matrix material having a dispensing performance ratio of at least about 0.6. The module also comprises an outer covering surrounding the capacitive matrix material. The outer covering comprises a gas passage valve. The gas passage valve includes a gas passage channel through the outer covering.

### BRIEF DESCRIPTION OF THE DRAWINGS

FIG. 1 is a schematic illustration of one embodiment of the invention.

FIG. 2 is a schematic illustration of a second embodiment of the invention.

### DETAILED DESCRIPTION OF THE INVENTION

A gas storage module is described. The gas storage module comprises a capacitive matrix material. The capacitive matrix material may consist of any porous material having the ability to store (e.g. adsorb) gas molecules. Exemplary matrix materials include activated carbon materials, including coconut carbon and carbon from other sources (such as coal, lignite, wood, etc.), zeolites, and metal-organic framework (MOF) materials.

The gas storage module has a capacitive storage ratio of at east about 3. The capacitive storage ratio is the ratio of the quantity of gas which may be stored in a fixed volume filled with the matrix material and the amount of gas which may be stored in the same fixed volume without the matrix material. The stored volumes are measured at equivalent temperatures and pressures as provided below.

In one embodiment, the matrix material may comprise active carbon derived from coconut and the capacitive storage ratio may be at least about 6. In one embodiment the matrix material may comprise MeadWestvaco's (Glen Allen, Va.) RGC narrow Particle Size Distribution (nPSD) powder wood-based activated carbon with nPSD (narrow Particle Size Distribution), and the capacitive storage ratio may be at least about 4. In one embodiment the matrix material may comprise MeadWestvaco's AquaGuard powder wood based activated carbon and the ratio may be at least about 3. In one embodiment the matrix material may comprise a carbon block comprising coconut activated carbon and a polyethylene binder and the ratio may be at least about 5.

In one embodiment the matrix material has a storage pressure ratio of at least about 7. For example, 100 mL of matrix material will store a particular volume of gas at a reference pressure of 60 psi. Storing this volume of the gas in an otherwise empty 100 mL vessel and the same temperature, results in a second pressure. The storage pressure ratio is the ratio of storage pressure without matrix material to storage pressure with matrix material. As an example, a particular matrix material may store 5.4 liters of gas at 60 psi. in a 100 mL volume. Storage of 5.4 liters of the gas in 100 mL without the matrix material results in a pressure of 650 psi. In this example, the storage pressure ratio is 650 divided by 60 or about 10.8.

In one embodiment, CO₂ is stored in a matrix of coconut activated carbon having a storage pressure ratio of about 10.8. In one embodiment, CO₂ is stored in a matrix of MeadWestvaco's RGC nPSD powder wood based activated carbon having a storage pressure ratio of about 7. In one embodiment, CO₂ is stored in a matrix of MeadWestvaco's AquaGuard powder having a storage pressure ratio of about 5. In one embodiment, CO₂ is stored in a matrix of coconut derived activated carbon in a polyethylene binder having a storage pressure ratio of about 9.

In one embodiment the matrix material may have a dispensing performance ratio of at least about 0.6. Dispensing performance ratio refers to the ratio of the volume of gas dispensed to the volume of gas stored. As an example, the dispensing performance ratio for a matrix material capable of storing 5 liters of CO₂ and subsequently releasing 2 liters would be 0.4. Dispensing performance ratio provides an indication of the amount of stored gas recoverable from the storage system.

The gas storage module further comprises an outer covering. The outer covering may be rigid or flexible. Metal, glass, ceramic and polymer coverings may be used. Composite coverings consisting of fibrous material with a binder may be utilized. Composite laminates consisting of polymeric layer metalized film layer, Mylar layers or other known packaging material layers may be utilized as the outer covering. The outer covering may be impermeable to the stored gas or semi-permeable to the stored gas. In embodiments where a semi-permeable covering is utilized the useful storage life of the gas storage module will be adversely affected. The outer covering may be formed and subsequently filled with the matrix material. The matrix material may be formed to a desired shape and subsequently covered with the outer covering material. The outer covering may be applied as a liquid and subsequently cured, by the application of sheet or film materials to the matrix material or by a combination of these methods.

The outer covering includes a valve. The valve comprises a gas channel through the covering. The valve may be as simple as a frangible potion of the covering which may be pierced. Piercing the covering may expose the matrix material to the environment outside the covering. Gas may move from the matrix material to the external environment through the piercing. In one embodiment the valve may comprise apparatus as are known in the art for selectively opening and occluding a gas passage through the covering. Inflation needles, foaming nozzles, dispensing nozzles and spray nozzles may be incorporated with or as part of the valve.

In one embodiment the module comprises a chamber within the outer covering in addition to the matrix material. The chamber may contain a product. Activation of the valve may result in the flow of product and stored gas in combination through the passage in the outer covering. In one embodiment, the matrix material may reside in the bottom of the module and product may reside above the material. Activation of the valve may release the relatively pressurized contents of the outer covering and induce the release of additional gas from the matrix material. In this embodiment, the outer covering may comprise a package shell. Valve systems including dip tube configurations, as are known in the art may be used to reduce the dispensing of just stored gas upon activation of the valve.

In one embodiment, the chamber and product contents may be separated from the matrix material by a movable element. In this embodiment, the outer covering encloses the product side of the movable element and the matrix side of the movable element. The element may provide a gas seal between the product side and the matrix side. The element may serve as a piston as product is dispensed. The element may be comprised of glass, ceramic, metal, composite, polymeric or other suitable materials and combinations of material. An o-ring or other suitable method may be used to provide the seal between the product and matrix sides.

Prior to valve activation, a steady state exists in the module at a pressure greater than the surrounding environment. Valve activation enables the movement of product from the chamber through the valve passage in the outer covering, into the surrounding environment. This movement lowers the pressure in the product side relative to the matrix side. This pressure differential induces movement in the element toward the valve passage to equalize the pressure between the product and matrix sides of the element. The equalization of the respective pressures translates to a pressure drop on the matrix side of the element. The pressure drop induces the release of gas from the matrix material until a steady state between the product and matrix sides of the element inside the covering is achieved.

In one embodiment, the movable element may comprise a flexible pouch, or container, at least partially filled with product. Upon activation of the valve, product may be dispensed from the element, lowering the pressure within the covering and enabling the release of additional gas from the matrix material. The additional gas may collapse the pouch restoring equalized pressure conditions on each side of the barrier.

In one embodiment, the gas storage module comprises a secondary covering. Gas released from the matrix material may collect between the material and the secondary covering. In one embodiment, the secondary covering may comprise a flexible polymeric or foil membrane. In this embodiment, the membrane may inflate due to the collection of the released gas. The inflation of the secondary covering may allow the pressure inside the secondary covering and beyond the secondary covering in the product chamber to equalize.

In one embodiment the gas storage module comprises a secondary covering and a movable element. In this embodiment, release of product via the valve reduces the pressure within the outer covering. Gas is released from the matrix material expanding the secondary covering and moving the movable element.

### EXAMPLES

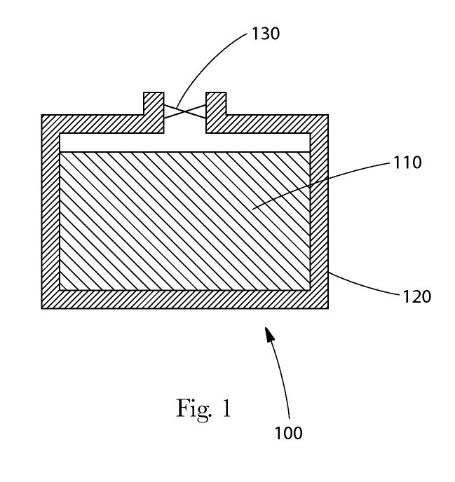

FIG. 1 schematically illustrates a cross-sectional view of an embodiment of the invention. As shown in the figure, a module 100 comprises a matrix material 110, an outer covering 120 and a valve 130. Activation of valve 130 allows gas (not shown) to dispense from the module 100.

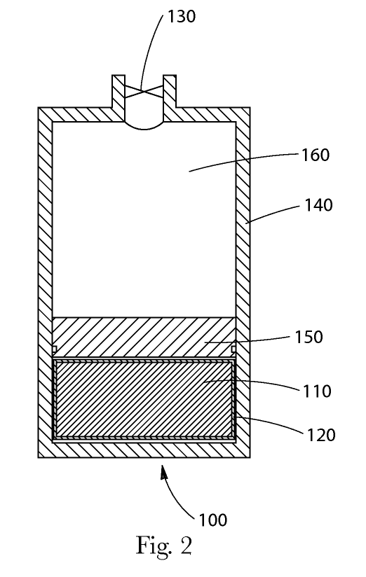

FIG. 2 schematically illustrates a cross-sectional view of an embodiment of the invention. As shown in FIG. 2, the module 100 comprises matrix material 110, an outer covering 120, valve 130, a secondary covering 140, a movable element 150, and product 160.

### Test Methods

A 100 mL vessel is evacuated to 29 in. Hg and allowed to regain ambient temperature. In the initial test the vessel is empty. In each subsequent test a storage matrix material is placed inside the vessel. CO₂ gas is then metered into the vessel at 200 mL/min while temperature and pressure in the vessel are monitored. The filling process continues until the flow drops off and a vessel pressure of 60 psig is attained. The vessel is again allowed to return to ambient temperature while remaining at 60 psig pressure. The volume of gas absorbed is estimated using the measured and timed gas flow rate.

After the vessel has regained ambient temperature, gas is released into an expansion vessel 125 mL in volume at 200 mL/min flow rate while monitoring the flow time, system temperature and pressure until the system attains ambient temperature and the final pressure is determined The amount of gas released from storage is determined using the timed flow measurements.

Storage pressure ratio is calculated as the ratio of the pressure of a volume of gas in an otherwise empty 100 mL vessel to the pressure of the same volume of gas in a 100 mL vessel filled with the storage matrix material at equivalent temperatures.

Storage capacity ratio is calculated as the ratio of the volume of gas which may be stored in 100 mL vessel filled with a storage matrix material to the volume of the same gas which may be stored in the same vessel without the storage matrix material in place. The two volumes are determined at equivalent temperatures and pressures.

Dispensing performance ratio is calculated as the ratio of the volume of gas dispensed when the storage vessel is opened to the expansion vessel to the volume of gas stored in a 100 mL vessel filled with a storage matrix material.

Final pressure is the pressure inside the storage and dispensing vessels when the stored gas is expanded into the dispensing vessel.

Table 1 provides the data obtained relating to the storage performance for the materials listed.

TABLE 1

| | Material | CO₂ | CO₂ Volume/ | Final |
|---|---|---|---|---|
| | Weight | Volume | Material Weight | Pressure |
| Storage Matrix Material Description | (g) | (L) | (L/g) | (psig) |
| 1. 97 Pacco Coconut 80 × 325 mesh size | 45.7 | 5.4 | .118 | 46.0 |
| 2. MeadWestVaco RGC nPSD | 35.1 | 3.6 | .103 | 43.5 |
| 3. 13X Zeolite Microsieve - Pellets | 70.0 | 5.4 | .077 | 28.6 |
| 4. MeadWestVaco AquaGuard | 26.5 | 2.8 | .106 | 41.6 |
| 5. TAC 600 | 56.3 | 3.6 | .065 | 32.9 |
| 6. RGC nPSD + pDADMAC | 36.7 | 3.0 | .082 | 40.2 |
| 7. 97 Pacco Coconut + PVAM | 48.6 | 4.5 | .092 | 40.7 |
| 8. 97 Pacco Coconut −325 mesh size | 41.2 | 4.4 | .107 | 42.0 |
| 9. 97 Pacco Coconut 40 μm size | 48.3 | 5.4 | .112 | 44.2 |
| 10. Fused 97 Pacco and 20% PE Binder | 45.0 | 4.6 | .104 | 44.3 |
| 11. Fused RGC nPSD and 20% PE Binder | 42.0 | 3.0 | .071 | 41.0 |

An empty 100 mL vessel stores a total CO2 volume of 0.8 L at 60 psig; 0.376 L of CO2 volume are released in a 125 mL expansion vessel at a final pressure of 22.2 psig.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A gas storage module, the module comprising:
a capacitive matrix material having a capacity ratio of at least about 3, and
an outer covering surrounding the capacitive matrix material,
wherein the outer covering comprises a valve, the valve comprising a fluid channel through the outer covering.

2. The storage module of claim 1 further comprising a secondary covering disposed between the capacitive matrix material and the outer covering.

3. The storage module of claim 1 wherein the capacitive matrix material has a capacity ratio of at least about 4.

4. The storage module of claim 1 wherein the capacitive matrix material has a capacity ratio of at least about 5.

5. The storage module of claim 1, further comprising:
a product,
stored gas.

6. The storage module of claim 5 further comprising a movable barrier between the capacitive matrix material and the valve.

7. A gas storage module, the module comprising:
a capacitive matrix material having a storage pressure ratio of at least about 9, and
an outer covering surrounding the capacitive matrix material,
wherein the outer covering comprises a valve.

8. The storage module of claim 7 further comprising a secondary covering disposed between the capacitive matrix material and the outer covering.

9. The storage module of claim 7 wherein the capacitive matrix material has a storage pressure ratio of at least about 10.

10. The storage module of claim 7, further comprising:
a product, and
stored gas,
wherein the outer covering comprises a package shell enclosing the product, the stored gas, and
the capacitive matrix material.

11. The storage module of claim 10 further comprising a movable barrier between the capacitive matrix material and the valve.

12. A capacitive gas storage module, the module comprising:
a capacitive matrix material having a dispensing performance ratio of at least about 0.6, and
an outer covering surrounding the capacitive matrix material,
wherein the outer covering comprises a valve, the valve comprising a fluid channel through the outer covering.

13. The storage module of claim 12 further comprising a secondary covering disposed between the capacitive matrix material and the outer covering.

14. The storage module of claim 12 wherein the capacitive matrix material has a dispensing performance ratio of at least about 0.7

15. The storage module of claim 12, further comprising:
a product,
stored gas.

16. The storage module of claim 15 further comprising a movable barrier between the capacitive matrix material and the valve.
